(19) United States
(12) Patent Application Publication
(10) Pub. No.: US 2013/0302010 A1
(43) Pub. Date: Nov. 14, 2013

(54) VIDEO RECORDER AND METHOD FOR ADJUSTING TIMESTAMP OF VIDEO RECORDER

(71) Applicant: HON HAI PRECISION INDUSTRY CO., LTD., New Taipei (TW)

(72) Inventors: CHENG-YI KUO, New Taipei (TW); TIEN-CHIEH KUO, New Taipei (TW)

(73) Assignee: HON HAI PRECISION INDUSTRY CO., LTD., New Taipei (TW)

(21) Appl. No.: 13/770,959

(22) Filed: Feb. 19, 2013

(30) Foreign Application Priority Data
May 11, 2012 (TW) 101117014

(51) Int. Cl. H04N 9/44

(52) U.S. Cl. CPC H04N 9/44
USPC 386/241

(57) ABSTRACT

In a method for adjusting a timestamp of a video recorder, a system time of the video recorder and a timestamp of a previous frame recorded by the video recorder are loaded when the video recorder records a new frame. The method determines whether the system time is after the timestamp, and adjusts the system time for a timestamp of the new frame when the system time is after the timestamp of the previous frame. The method further adjusts a time which is the timestamp of the previous frame with an addition of a preset time shift for the timestamp of the new frame when the system time is not after the timestamp of the previous frame, and saves the timestamp of the new frame into a storage device.

### BACKGROUND

1. Technical Field

The present disclosure is related to a video recorder and a method for adjusting a timestamp of the video recorder.

2. Description of Related Art

A video recorder device records a timestamp of a video frame captured by the video recorder, but a system clock of the video recorder device may be adjusted frequently causing problems. For example, a system time of the video recorder device may be synchronized by a network time protocol (NTP). When the system time is adjusted, a backtracking event occurs when recording the timestamp of the frame because the system time is backtracked. The backtracking event further causes problems for playing and searching. An overflowing record for recording frames of iterative timestamps, or multiple tracks for recording situations before adjustment and after adjustment can be adopted to solve the above problem. However, the above mentioned solutions are complicated and cannot perfectly solve the problems of obfuscating data loading caused by mistaking the timestamp, such as playing and searching, for example.

Therefore, there is room for improvement within the prior art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is an operation environment schematic diagram of one embodiment of a video recorder including a timestamp adjusting system.

FIG. 2 is a functional module diagram of one embodiment of the timestamp adjusting system of FIG. 1.

FIG. 3 is a schematic diagram of a video recorder including a timestamp adjusting system for adjusting the timestamp.

FIG. 4 is a flowchart of one embodiment of a method for adjusting timestamps of the video recorder of FIG. 1.

### DETAILED DESCRIPTION

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

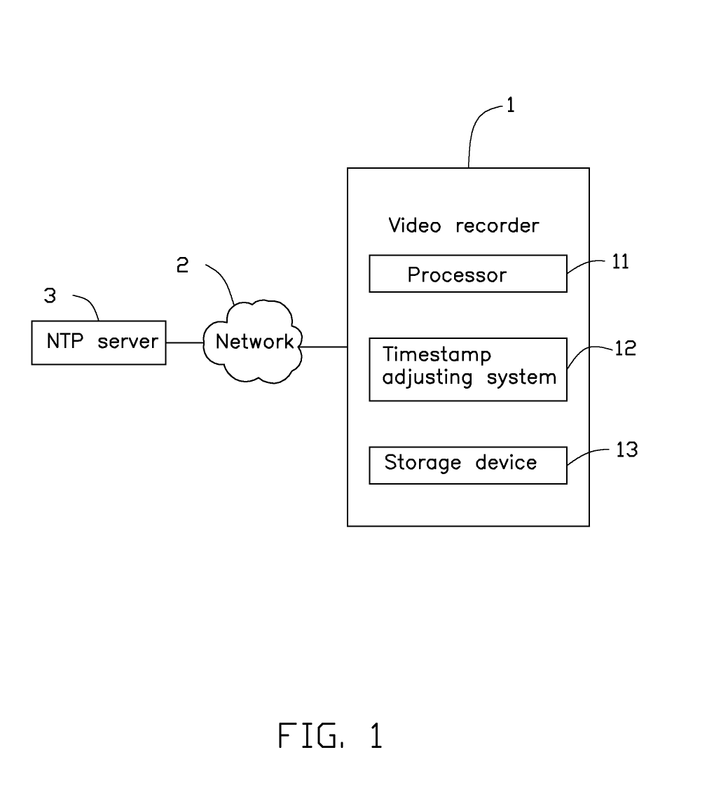

FIG. 1 is an operation environment schematic diagram of one embodiment of a video recorder 1 including a timestamp adjusting system 12. In the embodiment, the timestamp adjusting system 12 controls timestamping of the video recorder 1. The video recorder 1 may be a digital video recorder, for example. The video recorder 1 includes a processor 11 and a storage device 13. The processor 11 executes computerized functions of the timestamp adjusting system 12. The storage device 13 saves data of the video recorder 1. The video recorder 1 records each frame of each media data flow received by the video recorder 1 and saves a timestamp of the frame to ensure that an image of the timestamp can be searched or a video and an other multimedia can be played in an original speed according to the timestamp. In the embodiment, the timestamp of the frame is recorded according to a system time of the video recorder 1. The video recorder 1 communicates with a network time protocol (NTP) server 3 via a network 2. The system time of the video recorder 1 synchronizes with a time standard, such as the coordinated universal time (UTC) standard, for example, according to the NTP server 3. When the system time of the video recorder 1 synchronizes with the time standard according to the NTP server 3, the system time of the video recorder 1 is adjusted to ensure that the system time synchronizes with the time standard.

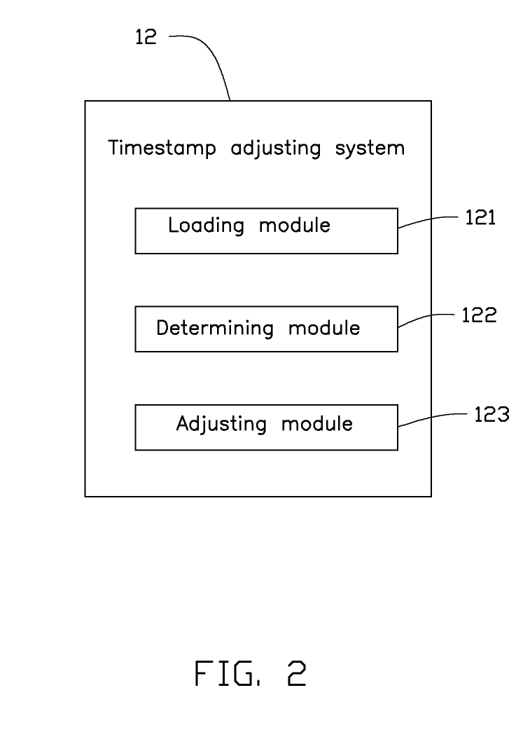

FIG. 2 is a functional module diagram of one embodiment of the timestamp adjusting system 12 of FIG. 1. The timestamp adjusting system 12 includes a loading module 121, a determining module 122, and an adjusting module 123. Modules are installed in the storage device 13 as a form of a software program or instruction and the modules are executed by the processor 11. The modules of the embodiment are segments for executing special functions.

The loading module 121 loads the system time of the video recorder 1 and a timestamp of a previous frame recorded by the video recorder 1 when a new frame is recorded by the video recorder 1. For example, an initial value of the timestamp of the previous frame is “zero” which means that the timestamp of the previous frame is a virtual 0th frame to ensure that a previous frame of a first frame can be obtained when the new frame is the first frame.

The determining module 122 determines whether the system time is after the timestamp of the previous frame.

The adjusting module 123 adjusts the system time for the timestamp of the new frame and saves the timestamp of the new frame into the storage device 13 when the system time is after the timestamp of the previous frame.

The adjusting module 123 also adjusts a time which is the timestamp of the previous frame with an addition of a preset time shift for the timestamp of the new frame and saves the timestamp of the new frame into the storage device 13 when the system time is not after the timestamp of the previous frame. The preset time shift may be set according to frames per second (FPS), and the preset time shift is smaller than a time interval of two continuous frames. For example, if the FPS is ten, the preset time shift may be set as zero point zero-one second.

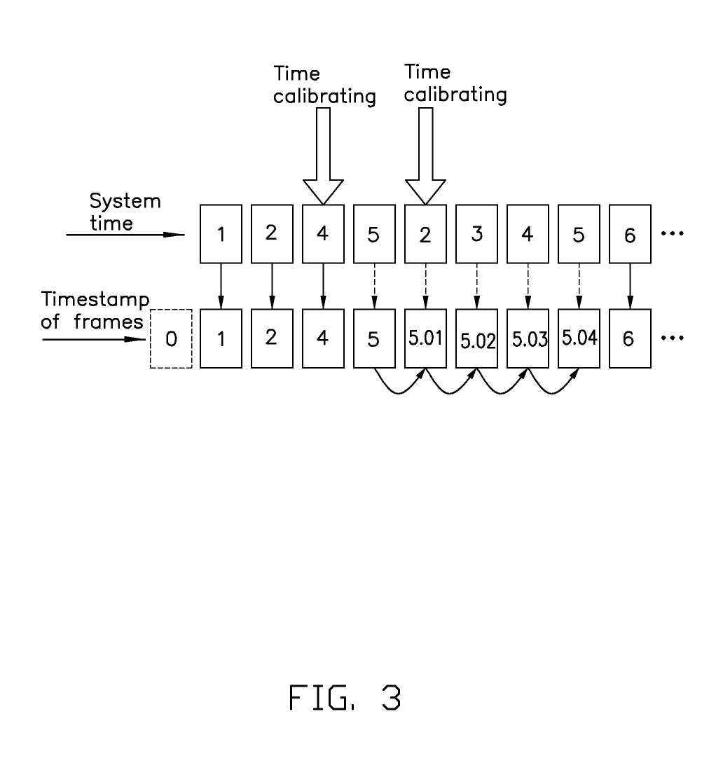

FIG. 3 is a schematic diagram of the video recorder 1 including the timestamp adjusting system 12. When a new frame is recorded by the video recorder 1, the loading module 121 loads the system time of the video recorder 1 and loads the timestamp of the previous frame. For example, if the system time is “one” and the timestamp of the previous frame is “zero,” and the adjusting module 123 adjusts the system time, “one,” for the timestamp of the new frame when the system time is after the timestamp of the previous frame. For example, if the system time which is adjusted by the NTP server 3 is “two” and the timestamp of the previous frame is “five,” and the adjusting module 123 adjusts the time which is the timestamp of the previous frame, “five”, with an addition of the preset time shift, “zero point zero-one”, for the timestamp of the new frame when the system time is not after the timestamp of the previous frame, wherein the timestamp of the new frame is “five point zero-one”. The embodiment ensures that when the video recorder 1 records the timestamp of the new frame, the video recorder 1 does not disorderly record the timestamp or cause the timestamp to backtrack after the NTP server 3 calibrating the system time of the video recorder 1. The embodiment perfectly solves a problem of disorderly loading data caused by disorderly recording the timestamp. A format of the timestamp is not limited to a format shown in FIG. 3.

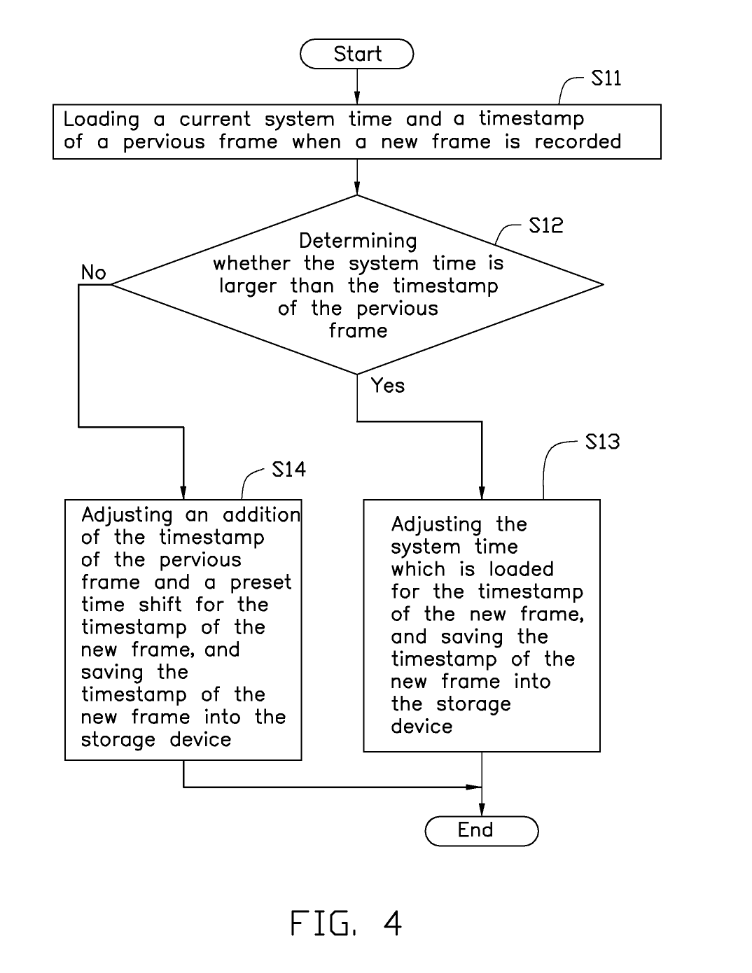

FIG. 4 is a flowchart of one embodiment of a method for adjusting timestamps of the video recorder of FIG. 1.

In step S11, when a new frame is recorded by the video recorder 1, the loading module 121 loads the system time of the video recorder 1 and loads the timestamp of the previous frame, and then step S12 is implemented. An initial value of the timestamp of the previous frame is “zero”, which means that the timestamp of the previous frame is a virtual 0th frame to ensure that a previous frame of a first frame can be obtained.

In step S12, the determining module 122 determines whether the system time is after the timestamp of the previous frame. If the system time is after the timestamp of the previous frame, then step S13 is implemented. If the system time is not after the timestamp of the previous frame, then step S14 is implemented.

In step S13, the adjusting module 123 adjusts the system time for the timestamp of the new frame, and saves the timestamp of the new frame into the storage device 13.

In step S14, the adjusting module 123 adjusts a time which is the timestamp of the previous frame with an addition of a preset time shift for the timestamp of the new frame, and saves the timestamp of the new frame into the storage device 13. The preset time shift is set according to FPS of the video recorder 1. The preset time shift is smaller than a time interval of two continuous frames. For example, when the FPS is ten, the preset time shift may be set as zero point zero-one second.

Depending on the embodiment, certain of the steps described may be removed, others may be added, and the sequence of the steps may be altered. It is also to be understood that the description and the claims drawn to a method may include some indication in reference to certain steps. However, the indication used is only to be viewed for identifier purposes and not necessarily as a suggestion as to an order for the steps.

The present disclosure is submitted in conformity with patent law. The above disclosure is the preferred embodiment. Any one of ordinary skill in this field can modify and change the embodiment within the spirit of the present disclosure, and all such changes or modifications are deemed included in the scope of the following claims.

What is claimed is:

1. A method for adjusting a timestamp of a video recorder, the method comprising:
loading a system time of the video recorder and a timestamp of a previous frame recorded by the video recorder when the video recorder records a new frame;
determining whether the system time is after the timestamp of the previous frame;
adjusting the system time for a timestamp of the new frame and saving the timestamp of the new frame into a storage device of the video recorder when the system time is after the timestamp of the previous frame; and
adjusting a time which is the timestamp of the previous frame with an addition of a preset time shift for the timestamp of the new frame, and saving the timestamp of the new frame into the storage device when the system time is not after the timestamp of the previous frame.

2. The method of claim 1, wherein the video recorder communicates with a network time protocol (NTP) server, and the NTP server synchronizes the system time of the video recorder with a time standard.

3. The method of claim 1, wherein an initial value of the timestamp of the previous frame is zero defining the timestamp of the previous frame to be virtual 0th frame.

4. The method of claim 1, wherein the preset time shift is set according to frames per second (FPS).

5. A video recorder for adjusting a timestamp, the video recorder comprising:
a storage device;
at least one processor; and
one or more modules stored in the storage device and executed by the at least one processor, the one or more modules comprising:
a loading module configured to load a system time of the video recorder and a timestamp of a previous frame which is recorded when the video recorder records a new frame;
a determination module configured to determine whether the system time is after the timestamp of the previous frame; and
a adjusting module configured to adjust the system time for a timestamp of the new frame, and to save the timestamp of the new frame into the storage device when the system time is after the timestamp of the previous frame, and to adjust a time which is the timestamp of the previous frame with an addition of a preset time shift for the timestamp of the new frame, and to save the timestamp of the new frame into the storage device when the system time is not after the timestamp of the previous frame.

6. The video recorder of claim 5, wherein the video recorder communicates with a network time protocol (NTP) server, and the NTP server synchronizes the system time of the video recorder with a time standard.

7. The video recorder of claim 5, wherein an initial value of the timestamp of the previous frame is zero defining the timestamp of the previous frame to be virtual 0th frame.

8. The video recorder of claim 5, wherein the preset time shift is set according to frame per second (FPS).

9. A non-transitory computer-readable storage medium having stored thereon instructions that, when executed by at least one processor of a video recorder, cause the processor to perform a method for adjusting a timestamp of the video recorder, the method comprising:
loading a system time of the video recorder and a timestamp of a previous frame recorded by the video recorder when the video recorder records a new frame;
determining whether the system time is after the timestamp of the previous frame;
adjusting the system time for a timestamp of the new frame and saving the timestamp of the new frame into a storage device of the video recorder when the system time is after the timestamp of the previous frame; and
adjusting a time which is the timestamp of the previous frame with an addition of a preset time shift for the timestamp of the new frame, and saving the timestamp of the new frame into the storage device when the system time is not after the timestamp of the previous frame.

10. The storage medium of claim 9, wherein the video recorder communicates with a network time protocol (NTP) server, and the NTP server synchronizes the system time of the video recorder with a time standard.

11. The storage medium of claim 9, wherein an initial value of the timestamp of the previous frame is zero defining the timestamp of the previous frame to be virtual 0th frame.

12. The storage medium of claim 9, the preset time shift is set according to frames per second (FPS).
